(19) United States
(12) Patent Application Publication
(10) Pub. No.: US 2004/0050333 A1
(43) Pub. Date: Mar. 18, 2004

(54) Modular milking parlor and transport system

(75) Inventor: Rolf W. Reisgies, Rhinelander, WI (US)

Correspondence Address: FOLEY & LARDNER, 150 EAST GILMAN STREET, P.O. BOX 1497, MADISON, WI, 53701-1497, US

(73) Assignee: DeLaval, Inc.

(21) Appl. No.: 10/643,521

(22) Filed: Aug. 19, 2003

Related U.S. Application Data
(62) Division of application No. 10/209,648, filed on Jul. 31, 2002.

(51) Int. Cl. A01J 3/00; A01J 5/00

(52) U.S. Cl. 119/14.04

(57) ABSTRACT

A modular milking parlor has a rigid frame on which the components of the milking parlor such as milking stations and cow control systems are mounted. The milking parlor frame includes a rectangular frame base and upright members extending upwardly from the frame base. The modular parlor can be conveniently shipped as a unit by attaching wheeled carriages to the frame of the modular parlor and elevating the milking parlor by operating jacks on the carriages attached to the wheels. The modular milking parlor as supported by the wheels may be rolled to a truck which transports the modular parlor to the installation site, and can be rolled on the wheels from the truck to the position at which the modular parlor is to be installed, at which point the carriage jacks are operated to drop the modular parlor on the ground, and the carriages are removed. A layer of concrete may be deposited over the frame base to install the modular parlor firmly in place and to provide a smooth and sanitary platform for cows entering the milking parlor.

### FIELD OF THE INVENTION

This invention pertains generally to the field of milking equipment and cattle handling equipment, and particularly to automated milking parlors.

### BACKGROUND OF THE INVENTION

In a typical modern milking parlor, several cows are milked simultaneously using various types of automated equipment such as milking stations that have automated detachers that sense when a cow has finished milking, cut off the milking vacuum, and detach the milking cluster from the cow. Automated detachers of this type are available commercially from several companies. One type of commercial detacher utilizes a flexible support arm that extends out under the udder of the cow being milked, where it is connected to the milking cluster, such that the cluster is held by the support arm off the ground after the cluster is removed from the cow.

Various configurations for milking parlors have been developed. One of the most commonly used is the so-called herringbone arrangement in which several cows are led into the milking parlor at the same time and are lined up at a diagonal to the length of the milking parlor. The rear of the cow faces the milking parlor pit where an attendant can reach the udder of each cow and attach the teat cups. The cows are generally led into the parlor single file adjacent to the milking stations, with the first cow being urged into the proper diagonal position by an exit gate which, in its closed position, extends at a diagonal to the lengthwise direction of the milking parlor. To constrain the cows as they enter the milking stalls and to urge the cows to assume the proper diagonal position, a restraining structure such as a fence or bar is mounted along the length of the milking stations in the parlor at a distance from the milking stations which is less than the front leg to back leg length of a cow. In some herringbone parlor designs, after all the cows have finished milking, the exit gate at the end of the parlor is opened and the cows leave the parlor in single-file. Individual exit gates have also been built to form the restraining barrier so that each cow can be individually released from the milking stall when it has finished milking. Other parlor designs have provided an exit barrier parallel to the line of milking stations which is held in the normal lower position adjacent to the front or brisket of a cow during milking, and which is raised to allow all the cows to exit at once when all the cows have finished milking. By raising the exit barrier (“brisket bar”) in this manner, all the cows can quickly leave the milking parlor with a minimum of pushing and shoving. A herringbone-type milking parlor having a brisket bar apparatus is shown and described in U.S. Pat. No. 4,951,608.

Milking parlors with automated milking equipment are relatively complex systems incorporating not only mechanical structures but also multiple vacuum lines, milk lines, and electrical and/or pneumatic power or control lines, which extend from the individual milking stations out of the parlor and into other parts of the parlor building. For example, the milk from the cows typically flows through milk lines under vacuum draw to a bulk cooler that is usually located in a separate room. The vacuum lines must be connected to vacuum pumps at locations outside the immediate vicinity of the parlor, and electrical and pneumatic lines extend to compressors or power supply systems outside of the parlor. Milking parlors have conventionally been constructed and assembled on site, requiring the installation of an appropriate concrete floor, the mounting of cow stanchions and support structures for the milking machines onto the floor of the parlor at proper positions, and the installation of the hoses, vacuum lines, and electrical wiring to each of the individual milking stations. The construction of milking parlors thus has been relatively time-consuming and expensive, and has required highly trained personnel to properly install and connect the various electrical and vacuum systems incorporated in the milking parlor, and to adjust and troubleshoot such systems so that the parlor operates correctly.

### SUMMARY OF THE INVENTION

A modular milking parlor in accordance with the present invention includes multiple milking stations pre-assembled in a row onto a rigid frame which is installed as a permanent part of the milking parlor. Each milking station may include an automatic detacher unit mounted to the frame at the preferred height and spacing between milking stations, so that no assembly of such units is required at the installation site. The various milk hoses, tubes, wires, pneumatic lines, etc. that are required to operate the detachers may preinstalled and supported by the frame of the modular parlor, avoiding the need for assembly of such systems on-site. Ancillary cow control systems, such as entrance and exit gates and a brisket bar system, are preferably also preinstalled and mounted on the frame of the modular parlor. Installation of the modular parlor of the invention can thus be carried out very quickly, commonly in a day or less, and with minimal adjustment and troubleshooting of the factory-installed systems being required to make the parlor operational.

The modular milking parlor of the invention has a rigid frame on which the various components of the milking parlor, such as the detacher units, are mounted. The milking parlor frame preferably includes a rectangular frame base with front and back longitudinal members that are joined together by lateral members that extend between the longitudinal members. A plurality of upright members are attached to and extend upwardly from the frame base, and at least one longitudinal support member is attached to the ends of upright members along the front side of the frame above the front of the frame base. At least one lateral support member extends laterally from an upright member positioned at the back side of the frame and is connected to the longitudinal support member to brace the longitudinal support member. A plurality of milking stations are mounted in a row to the frame between the frame base and the longitudinal support member at the front of the milking parlor. The various milk lines, vacuum lines, and control lines may be installed as a unit extending from each of the individual milking stations to a common position at an end of the milking parlor where they may either be connected to other pipes and lines or extended directly to equipment outside the milking parlor. The modular parlor also preferably includes a gutter mounted to the frame base members along the front longitudinal side of the modular parlor. A brisket bar apparatus is preferably mounted to upright members of the frame at the back side of the frame base with the brisket bar thereof extending longitudinally along the back side of the modular parlor.

The modular parlor of the invention may be shipped as a unit and installed as a unit in the building that houses the milking parlor. Installation may be carried out quickly and conveniently by setting the modular parlor in place, with the frame base resting on a surface that has been prepared for it, and then depositing a layer of concrete over the frame base to completely cover and encase the members of the frame base, with the upright members of the frame extending upwardly from the concrete layer. Installation in this manner provides parlor surfaces that are easily cleaned and meet high sanitation standards, while firmly mounting the entire parlor in place. Nonetheless, the parlor can be removed as a unit at a later time by breaking up the layer of concrete to free the frame base.

The present invention enables convenient transport and installation of the modular parlor as a unit from the factory to the installation site. In a preferred transportation system in accordance with the invention, wheeled carriages are temporarily attached to the frame at several positions to support the frame above the ground. Each wheel on the wheeled carriages is preferably mounted to a carriage base by a jack so that the height of the wheel with respect to the carriage base can be raised or lowered. The wheels are caster mounted to freely rotate about a vertical axis. The wheels are originally raised to a position where a connector on the carriage can be engaged with a portion of the frame while it is resting on the ground. After the carriages are attached to the frame, the jacks are operated to drive the wheels of each carriage away from the carriage base, to raise the frame off the ground so that the entire modular parlor is supported on the carriage wheels. The modular parlor may now be rolled as a unit to a position where it may, for example, be loaded onto a flatbed truck for transport to the installation site and, after unloading from the truck, it may be rolled to the position in the milking parlor building where the parlor is to be installed. The adjustable height wheels of the carriages facilitate the transport of the modular parlor as a unit over surfaces that may be rough or uneven. For example, if the parlor is rolled to a position at which the level of the surface rises, e.g., at a curb, the wheels on some of the carriages may be raised upwardly to a position in which they are above the higher level surface so that the modular parlor can be pushed forward until the front wheel are over the surface; these front wheels are then lowered to support a portion of the module on the higher surface. The wheels on the other carriages may similarly be raised progressively until the entire modular parlor is now supported on the higher surface. Similar adjustment of the heights of the wheels can be carried out where the surface level drops or where there are irregularities such as holes and cracks in the surface over which the modular parlor is being transported.

Further objects, features, and advantages of the invention will be apparent from the following detailed description when taken in conjunction with the accompanying drawings.

### BRIEF DESCRIPTION OF THE DRAWINGS

In the drawings:

FIG. 1 is a front elevation view of a modular milking parlor in accordance with the invention.

FIG. 2 is a back elevation view of the modular milking parlor of FIG. 1.

FIG. 3 is a top plan view of the modular milking parlor of FIG. 1.

FIG. 4 is a perspective view of the milking parlor frame of the modular milking parlor of FIG. 1, with wheeled carriages attached thereto to support the modular milking parlor during transport and installation.

FIG. 5 is a schematic view of a pneumatic jack system for adjustably controlling the height of the wheels of the wheeled carriages.

### DETAILED DESCRIPTION OF THE INVENTION

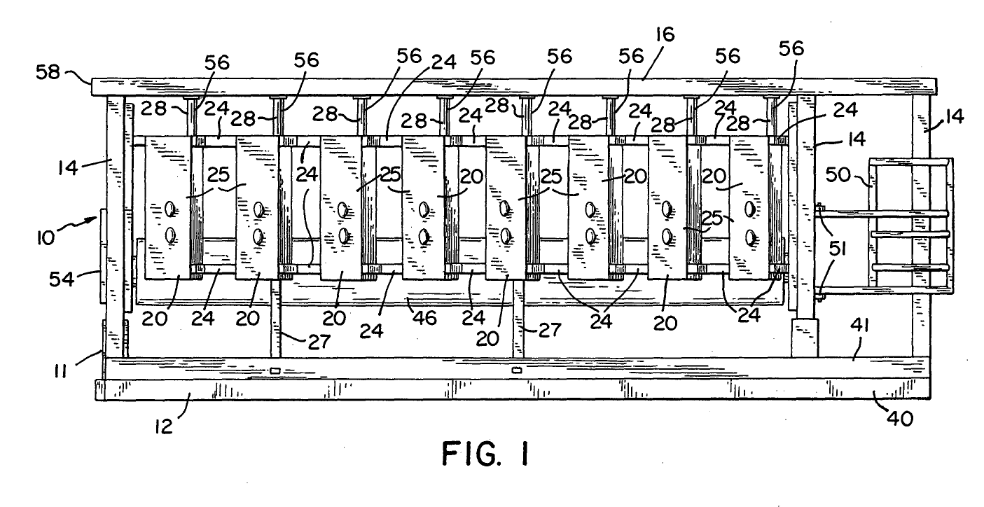

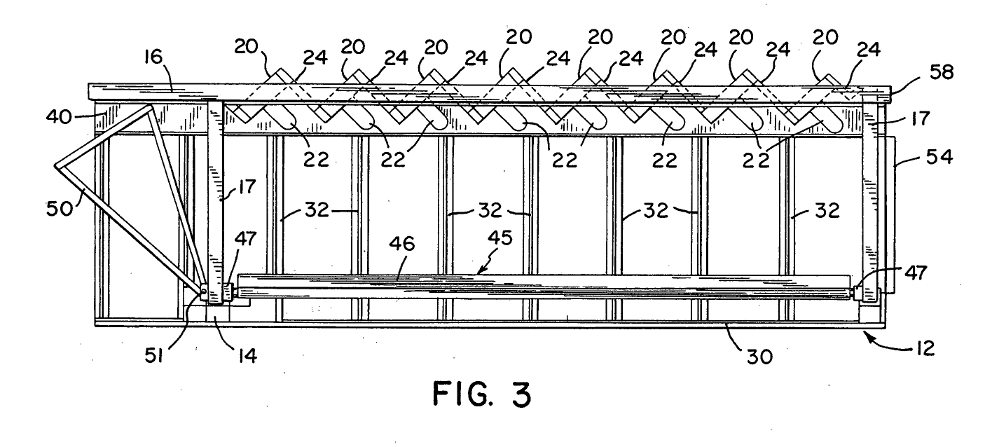

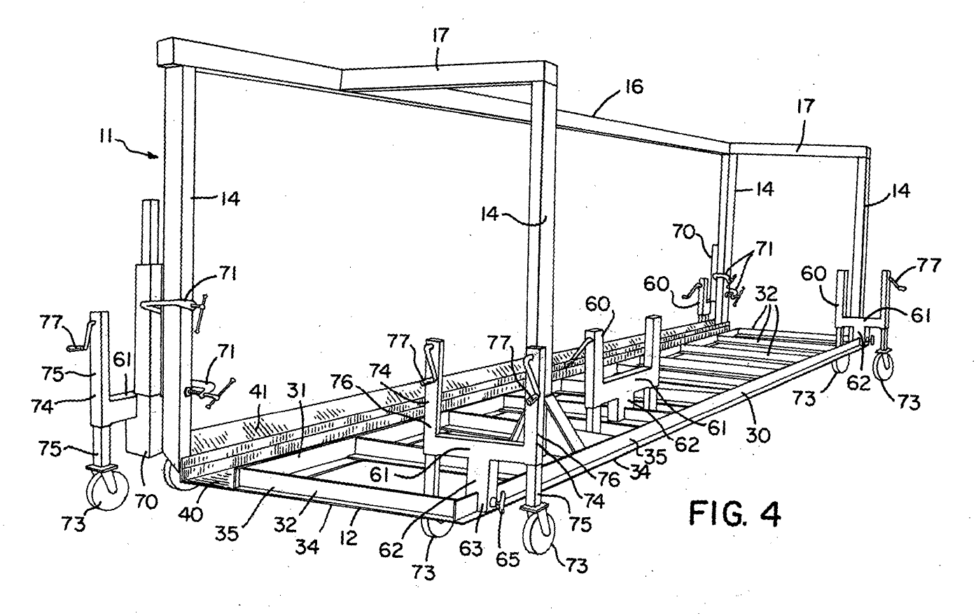

With reference to the drawings, a prefabricated modular milking parlor in accordance with the invention is shown generally at 10 in FIG. 1. The modular milking parlor 10 has a rigid milking parlor frame 11 that includes a rectangular base 12, a plurality of upright members 14 that are attached to and extend upwardly from the frame base 12, and at least one longitudinal support member 16 that is attached to the top ends of at least two of the upright members 14. The longitudinal support member 16 extends along the front side of the modular parlor. As best shown in FIGS. 3 and 4, the frame 11 further includes lateral support members 17 that are attached to the top ends of upright members 14 at the back of the frame and are connected to the front longitudinal support member 16 to provide rigid bracing to the longitudinal support member.

A plurality of milking stations 20 are mounted in a row to the frame 11 at the front side of the modular parlor 10. The eight milking stations 20 shown in FIG. 1 allow the milking of eight cows simultaneously in the parlor. Although eight stations are shown, more or fewer milking stations may be provided as appropriate. The milking stations 20 may be any of the various types of automated milking units that are employed in modern milking parlors, and such stations generally include an automatic detacher that senses when the flow of milk from the cow has reached a level indicating that the cow is substantially milked out, and then removes the teat cup cluster from the cow being milked. A preferred type of detacher unit includes a flexible milking cluster support arm, illustrated in a simplified view at 22 in FIG. 3. An example of a suitable detacher unit is manufactured by the Germania Dairy Automation Division of Delaval, Inc., but it is understood that any other type of commercial milking station (preferably with automatic detacher) may be utilized in the modular milking parlor of the present invention.

A preferred structure for mounting the milking stations 20 to the frame is shown in FIGS. 1 and 3 and utilizes support bars 24. The support bars 24 are welded or otherwise connected at each end of the row of milking stations to an upright support member 14 and to the housing 25 of the adjacent milking station 20. Support bars also extend between and are attached to the housings 25 of each adjacent milking station at the tops and bottoms of the milking stations 20 so that the support bars form, with the housings 25, a strong and rigid support for the milking stations 20. One or more upright posts 27 may be mounted at their bottom ends to the frame base 12 and extend upwardly to attach to the housing 25 of one or more of the milking stations 20 to provide further vertical support for the milking stations and to rigidify the overall structure. Support posts 28 may also extend downwardly from the longitudinal support member 16 to attachment to the housings 25 of the milking stations to provide further vertical support thereto. Generally, the structural members of the frame 11, the support bars 24, milking station housings 25, and posts 27 and 28 are made of a strong structural material such as galvanized steel or stainless steel.

As best illustrated in FIGS. 3 and 4, the frame base 12 includes parallel longitudinal structural members 30 and 31. Lateral structural members 32 extend between and are joined to the longitudinal members 30 and 31 at the periphery of the frame base and preferably at multiple positions intermediate the longitudinal ends of the frame base to provide a rigid rectangular structure. The structural members 30, 31 and 32 in the frame base 12 may be formed of T-shaped beams as illustrated in FIGS. 3 and 4, with each beam have a flat base 34 and an upright web 35 extending therefrom. The structural members 30, 31 and 32 of the frame base are preferably formed of a strong structural material, such as strong galvanized steel or stainless steel, and are rigidly secured together such as by welding or by other secure means. As also illustrated in FIGS. 3 and 4, a gutter 40 formed of an open topped, U-shaped structural member, is attached to the longitudinal frame member 31 at the front of the modular parlor and, as illustrated in FIGS. 3 and 4, effectively forms part of the frame base 12. The front upright members 14 are secured to the structural member 40 forming the gutter, as by welding. A splash panel 41 extends upwardly and outwardly from the gutter 40 and directs animal waste into the gutter 40. The gutter 40 and the splash panel 41 are also preferably formed of a strong and corrosion-resistant structural material such as stainless steel or galvanized steel.

While the milking parlor of the invention may utilize conventional exit and entrance gates, a preferred arrangement utilizes a brisket bar apparatus 45 of the type shown in U.S. Pat. No. 4,951,608, which is incorporated herein by reference. The brisket bar apparatus 45 includes a longitudinally extending brisket bar 46 which is mounted at its ends to a support mechanism 47 which is itself mounted to the side upright members 14 at the back side of the modular parlor. The brisket bar apparatus 45 can be operated to maintain the brisket bar 46 in its normal position shown in FIGS. 1-3 during milking and then, after all of the cows have finished milking, the brisket bar 46 may be raised above the heads of the cows to allow the cows to exit the parlor as a group. The milking parlor further includes an entrance gate 50 mounted by pivotal connections 51 to one of the back upright members 14 to swing between a closed position, as best illustrated in FIG. 3, and an open position in which the entrance gate 50 is swung aside to allow the cows to enter the milking parlor in the space between the brisket bar 46 and the row of milking stations 20. A swinging exit gate 54 or a stationary barrier may be mounted to the frame 11 at the longitudinal end of the milking parlor opposite that to which the entrance gate 50 is mounted.

Milking stations with automated teat cup cluster detachers have a variety of hoses and lines extending to them through the milking parlor. These include the milk hoses which draw the milk from the cow through the milking station to join a common milk line, vacuum pulsation lines leading to the teat cup cluster, and electrical or pneumatic power and control lines. In the modular parlor of the present invention, the hoses and lines preferably are preinstalled and extend together from each of the milking stations 20 in a group 56, which may be enclosed by a sleeve, up to the main longitudinal support member 16. The longitudinal support member 16 may be formed as a hollow support member with an enclosed cross-section. All of the various pipes, tubes and control lines from the milking stations 20 may then be run together through the interior of the longitudinal support member 16 to an end position 58 where such hoses, pipelines and control lines are available to be connected to or to extend to equipment outside of the milking parlor. If desired, the various hoses and lines may be passed through the hollow support posts 28. Alternatively, the groups 56 of lines and hoses may be run alongside the support member 16 to the end position 58 and may be covered, if desired, by an appropriate cover panel (not shown). A pre-assembled bundle may be formed which includes the pipelines and other lines as well as ancillary equipment, such as clean-in-place jetter holders, which can then be installed in the parlor on-site.

The modular milking parlor of the present invention is well-adapted to be transported as a unit from the factory to the installation site. Because of the strong and rigid construction of the frame 11 on which the other components of the modular milking parlor are mounted, the modular milking parlor 10 can be self-supported on temporary wheels. A separate truck or skid is not required to transport the assembled modular parlor in the factory and around the installation site. FIG. 4 illustrates the mounting of several (five shown) wheeled carriages 60 to various frame members to provide complete support to the modular parlor 10. For clarity of illustration, only the frame 11 of the modular milking parlor is shown in FIG. 4, and it is understood that the wheeled carriages may be mounted as shown in FIG. 4 to the completely assembled modular milking parlor 10.

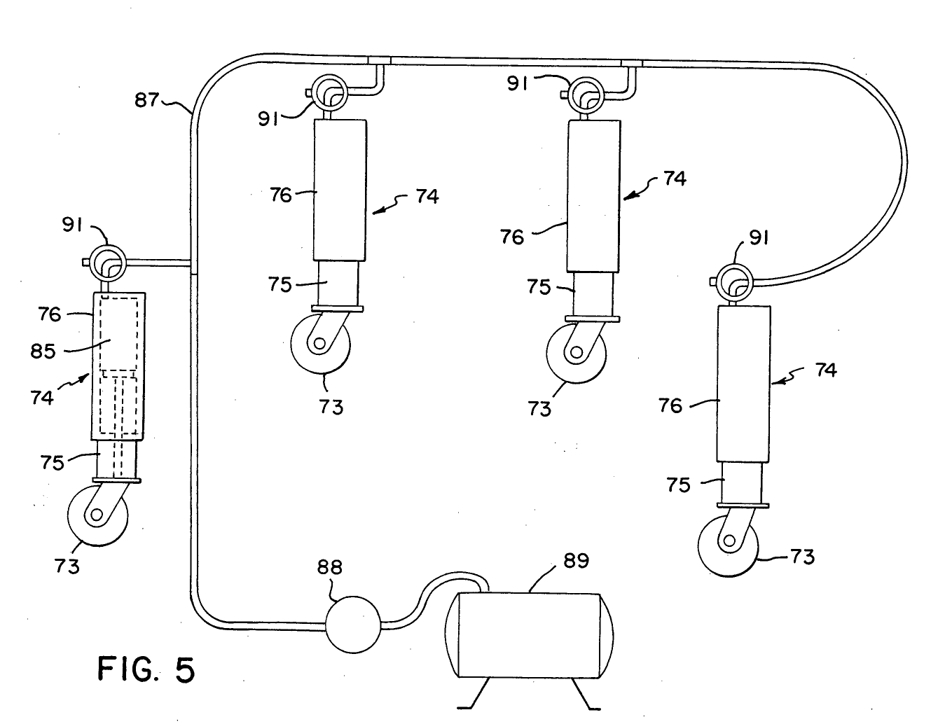

Each of the carriages 60 has a carriage body 61 which is releasably attached to one of the structural members of the frame 11. For example, the frontmost carriage 60 on the right-hand side of FIG. 4 is attached to the upright web 35 of the longitudinal member 30 by a downwardly extending section 62 of the carriage body which has a slot 63 formed therein which fits over the upright web 35. A hole drilled through the upright web 35 allows a hand turned bolt 65 to be threaded through an opening in one of the walls of the carriage section 62 and through the opening in the upright web 35 and then threaded into an opening on the other side of the section 62 to firmly connect the longitudinal frame member 30 to the carriage 60. Alternatively, the carriage 60 shown on the left-hand side of FIG. 4 has a post 70 mounted to it, e.g., by welding or bolting the post 70 to the carriage body 61, with the post 70 then being firmly attached to one of the upright members 14 by clamps 71. All such structures and all equivalent structures shall be considered means for releasably connecting the carriage body to a structural member. Similar carriages 60 are mounted to the frames 11 of the modular parlor at positions near the back corners of the frame as illustrated in FIG. 4, and a carriage 60 is also preferably connected to the upright web 35 of one of the lateral base members 32 to provide additional support for the modular parlor at a position near the center of the frame base. Each of the carriages 60 has swiveling caster type wheels 73 which are each attached to a jack 74 (e.g., similar to a trailer jack) having a post 75 that can slide upwardly and downwardly in an upright hollow sleeve 76 of the carriage body 61. Suitable jacks are available commercially, e.g., from Northern Tool & Equipment Co. A hand crank 77 is connected to a ratchet mechanism within each jack 74 and can be turned by hand to move the post 75 and the wheel 73 connected to it upwardly or downwardly with respect to the carriage body 61. Thus, by turning the crank 77, an operator can raise or lower the wheel 73 with respect to the frame of the modular parlor, and the relative height of each of the wheels 73 on the carriages 60 can be adjusted individually to account for changes in the surface terrain over which the modular parlor is being moved as supported by the wheeled carriages 60. The wheels 73 may be adjustably mounted by other jack mechanisms, e.g., electrical or pneumatic drivers, that allow an operator to control the raising or lowering of several wheels 73 at one time. In an exemplary pneumatically adjusted carriage system, as illustrated schematically in FIG. 5, an air pressure operated piston-cylinder (e.g., 3 in. diameter), one of which is shown in dashed lines in FIG. 5, can replace the screw of a conventional trailer jack. The cylinders 85 on each of the carriages 60 may be connected to a common air supply line 87 which extends to a regulator 88 and a reservoir tank 89 that travel with the modular parlor 10. The reservoir tank is charged to an appropriate pressure level (e.g., 140 to 160 psi for a 10 gallon tank). The pressure regulator 88 regulates the pressure supplied to the cylinders. After the carriages 60 are attached to the frame 11 (while it is resting on the ground), the regulator 88 may be adjusted to supply sufficient pressure to raise the frame off of the ground (e.g., in the range of 3 inches). As the modular parlor supported by the carriages 60 is moved, if a wheel encounters a rise, it assumes more weight. The pressure in the cylinder connected to that wheel-and therefore the pressure in the entire system-increases (e.g., from 90 psi to 91 psi). In response, the regulator 88 (set, e.g., to 90 psi) maintains that pressure to all wheels so that the wheel displaces with the rising terrain while continuing to bear a relatively constant portion of the weight of the parlor. A valve 91 (e.g., a three-way valve) is preferably connected between the air supply line 87 and each air cylinder 85. The valves 91 can each be manually operated to supply air under pressure from the line 87 in one position of the valve and to vent the air cylinder in another position of the valve. When a wheel 73 encounters a sharp rise (such as at a curb) the valve 91 controlling the air supplied to the air cylinder 85 connected to that wheel can be opened to release the pressure on the wheel, allowing the wheel to be manually raised to a new height to clear the rise, and the valve 91 can then be closed to apply pressure to the wheel to engage the higher surface. Such air cylinder-piston drives, hand operated mechanical screw jacks, electrically operated jacks and all equivalent devices shall be considered as means for adjustably mounting the wheels to the carriage body so that the wheels can be moved up and down with respect to the carriage body.

The carriages 60 at the center and back of the module 10 are initially attached to the frame 11 when the frame is resting on the ground, with the posts 75 connected to the wheels 73 drawn up into the sleeve sections 76 sufficiently to allow the slot 63 of the support member 62 to fit over the web 35 of a structural member, and to allow the bolt 65 to be threaded in to make the connection between the carriage and the structural member. The carriages 60 at the front of the modular parlor are also attached to the upright members 14 with the wheels 73 drawn preferably as far as possible toward the carriage bodies 61. The cranks 77 on the carriages are then turned by the operator to drive the post 75 and the wheel 73 connected thereto for each carriage outwardly from the carriage body 61 and thereby elevate the section of the frame to which carriage 60 is connected off the ground. The operator can turn the crank 77 on each of the carriages as appropriate to have the carriages 60 completely suspend the modular parlor off the ground at a uniform height, preferably with each wheel 73 contacting the ground surface and providing support for the modular parlor.

After the carriages 60 have been mounted to the modular parlor and the parlor elevated so that it is suspended above the ground by the carriages 60, the modular parlor 10 is ready for transport as a unit to the dairy where it will be installed. The entire parlor can be pushed or pulled, as supported by the wheeled carriages 60, from the factory floor to the loading dock and preferably directly onto the bed of a flatbed truck that is at the same level as the loading dock. If necessary, the entire modular parlor can be transferred to a truck by use of a forklift, etc. The modular parlor 10 is secured to the bed of the truck and transported to the dairy where it is to be installed. For certain new installations, the truck may be able to back up to a platform which extends into the dairy building where the parlor is to be installed, allowing the modular parlor 10 supported by the carriages 60 to be rolled off of the truck and directly onto the platform, and thence into the position in the parlor building at which the modular parlor is to be installed. However, the present invention also allows the modular parlor to be transported into new or preexisting parlor buildings where direct unloading onto the platform of the parlor is not possible. In such cases, the truck carrying the modular parlor is parked as close possible to the parlor building and the modular parlor 10 is removed as a unit from the truck, either by rolling it off on a ramp or utilizing a forklift to lift the parlor 10 as a unit off of the truck and onto the ground. Once on the ground, the modular parlor then may be pushed or pulled over the ground surface to the position in the parlor building where it is to be installed. A particular advantage of the adjustable-height wheeled carriages 60 is that changes in the elevation of the terrain over which the modular parlor is being transported can be readily accommodated without requiring lifting of the entire modular parlor by a forklift or other external mechanism. For example, if the modular parlor must go over a curb or other small change in elevation, the leading end wheels 73 can be drawn upwardly to a point where one or more of the wheels is above the level of the curb, allowing the modular parlor to be pushed to position where those wheels are all above the curb, after which the wheels can be lowered to provide support for that end of the modular parlor. The other set of leading wheels can be drawn up in a similar manner to allow them to clear the curb and then be driven back down to provide support for the modular parlor. A similar procedure can be used with all of the other wheels 73 on the other carriages 60. Similar adjustment of the height of the wheels can be used to accommodate rough terrain such as potholes or cracks in concrete, etc.

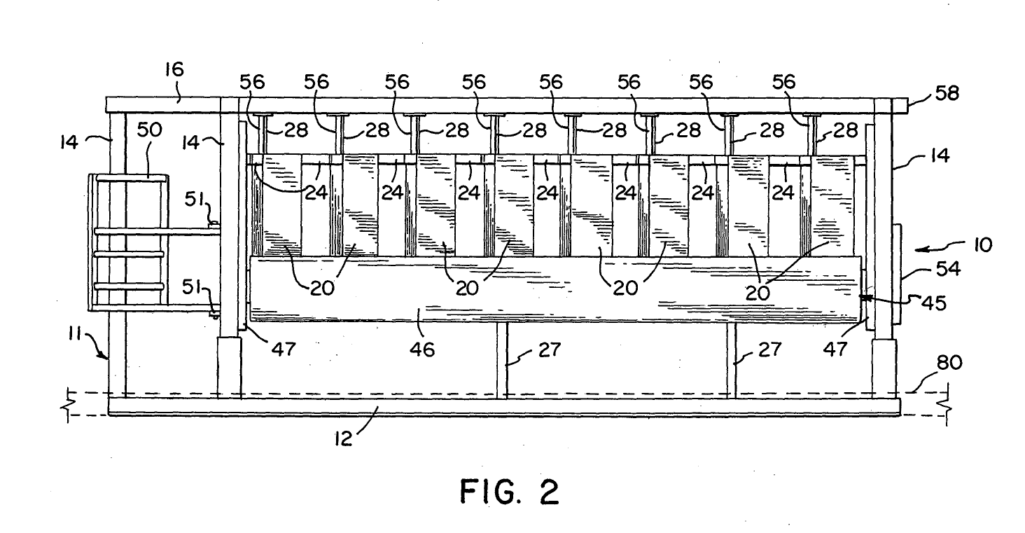

Once the modular parlor 10 has been brought into the parlor building and is positioned at the site at which it is to be installed, the cranks 77 can be turned by the operator to lower the modular parlor until the frame base 12 rests on the surface at the proper position at which the parlor is to be installed. The carriages 60 are then detached from the modular parlor 10, leaving the modular parlor fully self-supported on the ground. If necessary, the modular parlor 10 can be moved by sliding it on the ground to precisely locate it in the desired position, and supporting material or shims may be added under the frame base 12 as necessary to precisely level the modular parlor. A layer of concrete may now be poured over the frame base 12 to entirely cover the longitudinal and lateral structural members 30, 31 and 32 of the frame base. The surface of the concrete layer is smoothed and treated as appropriate to provide a smooth, sanitary surface to support the cows during milking in the modular parlor. The layer of concrete, illustrated by the dashed lines 80 in FIG. 2, further serves to anchor the modular parlor 10 firmly in place in the milking parlor. Although the modular parlor at this point is essentially permanently installed, if, at a later time, it is desired to remove the parlor, removal can be accomplished easily by breaking up the concrete layer 80 that covers the frame base 12. Once the modular parlor 10 is installed in its proper position, the milk lines, vacuum lines, and pneumatic or electrical power lines can be connected at the end 58 of the parlor at which the preinstalled hoses, pipelines, and lines extending to the various milking stations 20 are located. In this manner, installation of the milking parlor 10 can be carried out in a day or two with a minimum need for skilled technical personnel and with the milking stations 20 pre-adjusted at the factory so that they are ready for milking.

It is understood that the invention is not limited to the particular construction and arrangement of parts set forth herein, but embraces all such forms thereof that come within the scope of the following claims.

What is claimed is:

1. A method of transporting and installing a modular milking parlor comprising:
(a) providing a modular milking parlor having a rigid milking parlor frame including a rectangular frame base including lateral and longitudinal members joined together to define a front side and a back side of the milking parlor, and a plurality of milking stations mounted in a row to the milking parlor frame above the frame base;
(b) attaching wheeled carriages to the frame of the modular milking parlor, each wheeled carriage having a carriage body and a caster wheel that can be raised or lowered with respect to the carriage body, the carriages being attached to the modular milking parlor with the frame base resting on the ground;
(c) raising the modular milking parlor off of the ground by advancing the wheels of each carriage away from the carriage body to lift the carriage body and the frame of the milking parlor attached thereto;
(d) rolling the modular milking parlor as supported by the wheels of the carriages over at least part of the transport of the modular milking parlor to a site where the modular milking parlor is to be installed; and
(e) at the site at which the modular milking parlor is to be installed, withdrawing the wheels of the carriages to drop the modular milking parlor down until the frame base rests on the surface of the site and then removing the carriages from the frame of the modular milking parlor.

2. The method of claim 14 including the further step of depositing a layer of concrete over and covering the frame base of the modular milking parlor after it is positioned at the installation site.

3. The method of claim 14 wherein the modular milking parlor supported by the wheels of the carriage is rolled from a point of assembly of the modular milking parlor to a flatbed truck, including the steps of loading the modular milking parlor with the carriages attached thereto onto the truck, transporting the modular milking parlor on the truck to a position near the site at which the modular milking parlor is to be installed, unloading the modular milking parlor from the truck and rolling the modular milking parlor supported by the wheels of the carriages to the site at which the modular milking parlor is to be installed.

4. The method of claim 16 further including adjusting the height of the wheels of the carriages as the modular milking parlor is rolled from the truck to the point of installation to accommodate changes in the height of the terrain over which the modular milking parlor is being rolled.

5. A method of installing a modular milking parlor comprising:
(a) providing a modular milking parlor having a rigid milking parlor frame including a rectangular frame base and a plurality of milking stations mounted in a row to the milking parlor frame above the frame base;
(b) positioning the modular milking parlor at the site at which it is to be installed with the frame base resting on a surface at the position at which the modular milking parlor is to be installed; and
(c) depositing a layer of concrete over the frame base to cover and enclose the frame base.

6. A wheeled carriage suited for transporting a modular milking parlor, comprising:
(a) a carriage body;
(b) a plurality of caster wheels;
(c) means for adjustably mounting the wheels to the carriage body so that the wheels can be moved up and down with respect to the carriage body; and
(d) means for releasably connecting the carriage body to a structural member.

7. The wheeled carriage of claim 34 wherein the means for adjustably mounting the wheels to the carriage body includes a hand operated jack connected to each wheel.

8. The wheeled carriage of claim 34 wherein the means for releasably connecting the carriage body to a structural member includes a downwardly extending section of the carriage body with a slot therein formed to fit over an upright web of a structural member, and a bolt threaded through openings in walls of the downwardly extending section at the slot in the section such that the bolt can be passed through an opening in an upright web of a structural member.

9. The wheeled carriage of claim 34 wherein the means for adjustably mounting the wheels to the carriage body includes an air pressure operated piston-cylinder connected to each wheel.

10. The wheeled carriage of claim 37 further including a valve connected to each piston-cylinder and operable to supply air under pressure in one valve position and to release air in the piston-cylinder in another position.
